(19) United States
(12) Patent Application Publication
(10) Pub. No.: US 2007/0279917 A1
(43) Pub. Date: Dec. 6, 2007

(54) Light assembly and stackable light shade for use therein

(75) Inventor: Soledad Maria Reeve, British Columbia (CA)

Correspondence Address: KLARQUIST SPARKMAN, LLP, 121 SW SALMON STREET, SUITE 1600, PORTLAND, OR, 97204, US

(73) Assignee: University of Victoria Innovation and Development Corporation

(21) Appl. No.: 11/809,759

(22) Filed: Jun. 1, 2007

Related U.S. Application Data
(60) Provisional application No. 60/810,523, filed on Jun. 2, 2006.

(51) Int. Cl. F21V 11/00

(52) U.S. Cl. 362/351

(57) ABSTRACT

A light shade for shrouding a light source is provided. The light shade is made by releasably attaching a sheet of a moldable, translucent laminate material to at least one mount with at least two fasteners, to define a space, wherein the sheet has an area larger than an area defined by the mount and the light source is located within the space, thereby shrouding the light source with the light shade.

### CROSS REFERENCE TO RELATED APPLICATION

This application claims the benefit of U.S. Provisional Patent Application No. 60/810,523, filed Jun. 2, 2006 and entitled “Light assembly and stackable light shade used therein,” which is hereby incorporated herein by reference.

### FIELD

The technology relates to a light assembly that uses a stackable light shade. More specifically, the technology relates to a self-forming, self-supporting shade comprised of a translucent moldable laminate material.

### BACKGROUND

Lamp and light shades are comprised of a variety of materials, including glass, polymers, fabric and paper. In general, the materials are draped over a framework, which may be metal, a rigid polymer or wood, for example. One of the problems with such lampshades is that they are bulky and are therefore difficult to ship and store. Accordingly, there has been an effort to develop folding lamp shades. For example, US Patent Application Serial Number 20040184271 discloses a foldable lamp shade that includes an upper support hoop, a lower support hoop, a cover mounted between the upper support hoop and the lower support hoop, and a plurality of support bars detachably mounted between the upper support hoop and the lower support hoop for supporting and stretching the cover. Thus, the user only needs to insert the locking tenons of each of the support bars into the locking slide slot of the respective locking lug of each of the upper support hoop and the lower support hoop so as to assemble the foldable lamp shade, thereby facilitating assembly and disassembly of the foldable lamp shade.

Another foldable lamp shade is disclosed in US Patent Application Serial Number 20050105293. The lamp shade includes a shade, and a support structure mounted in the shade for supporting the shade. The support structure includes a first ring fixed on a first end of the shade, a second ring fixed on a second end of the shade, and an elastic member mounted between the first ring and the second ring. Thus, the lamp shade is folded when not in use so as to reduce the volume of the lamp shade, thereby facilitating package, storage and transportation of the lamp shade, and thereby decreasing the costs of transportation.

Yet another foldable lamp shade is disclosed in US Patent Application Serial Number 20040076012. The lampshade has an assembled state and a collapsed state includes a first ring, a second ring spaced apart from the first ring when the lampshade is in the assembled state, and a first fabric covering interconnecting the first and second rings. A third ring is located adjacent the first ring when the lampshade is in the assembled state. A plurality of supports are connected between the second ring and the third ring. Each support has a first end portion movably connected to the second ring and a second end portion movably connected to the third ring. The supports hold the second and third rings spaced from each other. The supports urge the third ring into engagement with the first ring thereby to hold the first ring spaced apart from the second ring.

While these shades reduce the shipping and storage volume, they require a significant amount of assembly. Also, the supporting structure can be seen in the assembled product. Not only is the supporting structure unsightly, it contributes to shadowing and unwanted reflection.

A primarily self-supporting shade (hood) is disclosed in US Patent Application Serial Number 20030147243. It is adapted to create an illuminating light sculpture functioning as a source of illumination as will as a work of abstract or figurative art. The hood of the assembly is molded of translucent elastomeric material to assume the desired form of sculpture which has a cavity therein to accommodate the envelope of an electric lamp enclosing the light generating components to which power is supplied. When the lamp is turned on, the sculpture is then internally illuminated, rays passing through the translucent hood being diffused thereby to illuminate an external region with “soft” rays. The different thicknesses of the hood material produced by indentations and depression which express the artistic form of the hood result in corresponding differences in the intensity of light radiated from the hood to create a pattern of light that defines the sculpture. While this lamp shade overcomes the deficiencies in the prior art, with regard to a lack of need for a supporting structure, it is bulky and therefore occupies far too much space to be packed and shipped efficiently.

It is an object of the present technology to overcome the deficiencies in the prior art.

### SUMMARY

In one embodiment a light shade for use with a light source is provided. The light shade is comprised of a sheet of a moldable, translucent laminate material and releasable fasteners, wherein the light shade is formed into a stackable shape.

In one aspect, the light shade is further defined as a nesting shape.

In another aspect, the laminate comprises at least three layers.

In another aspect, at least one middle layer comprises light opaque or translucent material.

In another aspect, the material is selected from the group consisting of organic material, metal foil, metal chips, plastic material and plastic chips.

In another aspect, the organic material is selected from the group consisting of handmade paper, canvas, hemp, cotton, linen, silk, other fabrics and dried plant material.

In another aspect, the fasteners are grommet and toggle pairs.

In another aspect, the stackable, nesting shape is a sconce, a trough, a cone or a ripple.

In another embodiment a light assembly comprising a light source, a receptacle, an at least one mount and a light shade is provided. The light shade comprises a sheet of a moldable, translucent laminate material comprising at least three layers, wherein at least one middle layer comprises light opaque or translucent material, wherein the light shade is releasably affixed to the at least one mount with at least two fasteners, to define a space, wherein the sheet has an area larger than an area defined by the at least one mount and the light source is located within the space.

In one aspect, the shade is formed into a stackable, nesting shape.

In another aspect, the stackable, nesting shape is a sconce, a trough, a ripple, or a cone.

In another embodiment, a method of manufacturing a light assembly comprising a stackable, nesting light shade is provided. The method comprises:

(i) molding a sheet of moldable, translucent laminate material to produce a pre-formed nestable shape; and

(ii) releasably attaching the pre-formed nestable shape to an at least one mount with at least two fasteners, to define a space, wherein a light source is located within the space, thereby manufacturing a light assembly.

In one aspect, the method further comprises selecting a square sheet and molding it into a sconce, a trough or a ripple shape.

In another aspect, the method further comprises selecting a triangular sheet and molding it into a cone shape.

In another aspect of the method, the laminate material comprises at least three layers.

In another embodiment, a light shade for shrouding a light source is provided. The light shade is made by releasably attaching a sheet of a moldable, translucent laminate material to an at least one mount with at least two fasteners, to define a space, wherein the sheet has an area larger than an area defined by the at least one mount and the light source is located within the space, thereby shrouding the light source with the light shade.

In one aspect of the light shade, the laminate comprises at least three layers.

In another aspect the at least one middle layer comprises light opaque or translucent material.

In another aspect the material is selected from the group consisting of organic material, metal foil, metal chips, plastic material and plastic chips.

In another aspect the organic material is selected from the group consisting of handmade paper, canvas, hemp, cotton, linen, silk, other fabrics and dried plant material.

In another aspect the light shade comprises a square sheet and four fasteners.

In another aspect the light shade comprises a triangular sheet and three fasteners.

In another aspect the fasteners are grommet and toggle pairs.

### BRIEF DESCRIPTION OF THE DRAWINGS

FIG. 1 An exploded view of a wall sconce in accordance with an embodiment of the technology.

FIG. 2 An exploded view of a wall washer in accordance with an embodiment of the technology.

FIG. 3 An exploded view of a wall washer in accordance with an embodiment of the technology.

FIG. 4 An exploded view of a ceiling light fixture in accordance with an embodiment of the technology.

### DETAILED DESCRIPTION

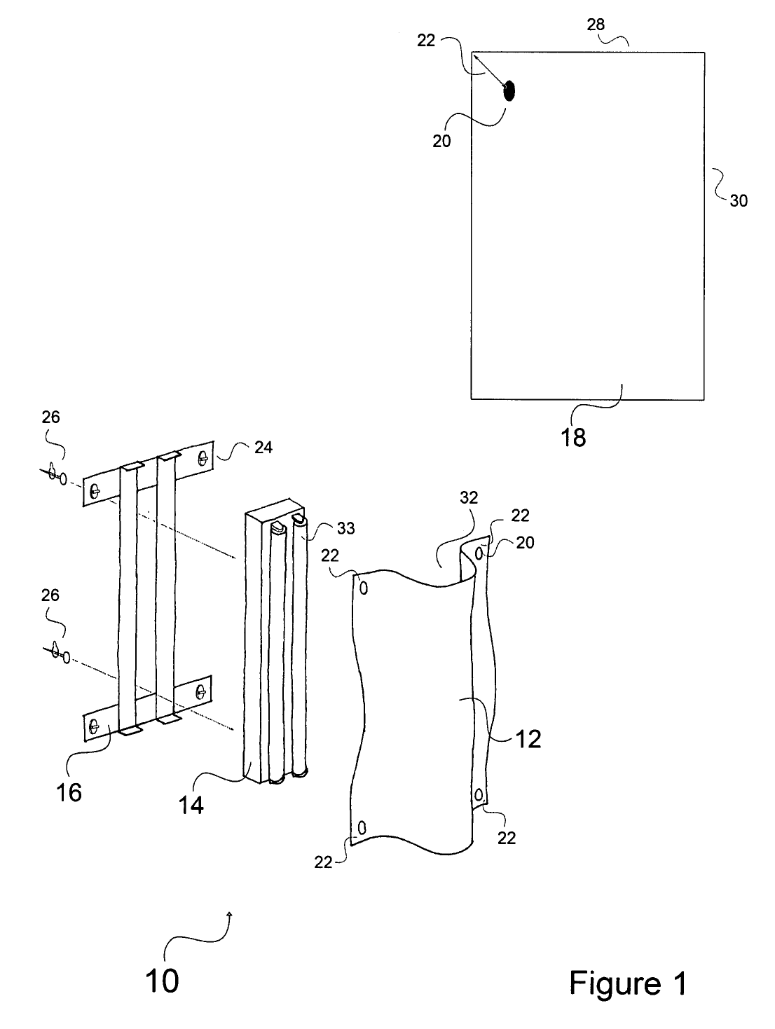

As shown in FIG. 1, in one embodiment, a lamp in the form of a wall sconce, generally referred to as 10 is provided. The wall sconce 10 has a light shade 12, a receptacle 14 and a mount 16. The light shade 12 is comprised of a square sheet, which is preferably a rectangular sheet 18 of a moldable translucent laminate material, such as 3-Form™ that is molded into a vase-like shape. Grommets 20 are located proximate to each corner 22. Toggles 24 are mounted on the mount 16. The mount can be affixed to a wall by means of screws 26. The toggles 24 are mounted to the mount 16 a distance that is approximately ⅔s the width 28 of the sheet 18, and approximately 9/10s the length 30 of the sheet 18, such that the light shade 12 defines a space 32 between the shade 12 and the mount 16 for housing a light source 33. The light source 33 is screwed into or otherwise attached to the receptacle 14, which is mounted on the mount 16. The light source 33 is preferably a fluorescent light. The toggles 24 permit the shade 12 to be removed as needed, whether for cleaning or for changing the light source 33. The toggles 24 and grommets 20 can alternatively be replaced by any type of fasteners.

The light shade 12 is a stackable molded form that, when fastened to the mount 16, shrouds the light source or is a stackable, flat sheet that is molded into the desired form when fastened to the mounts 16, thereby shrouding the light source.

The sheet can range in thickness from about 1/16^{th} of an inch to about ½ of an inch, with the outer layers being about a minimum of 1/32^{nd} of an inch thick and the middle layers totaling about a maximum of 7/16^{th} of an inch thick. The following patents and patent applications disclose a number of products that would be suitable: U.S. Pat. No. 5,643,666, U.S. Pat. No. 5,894,048, U.S. Pat. No. 5,958,539, U.S. Pat. No. 5,998,028, U.S. Pat. No. 6,025,069, U.S. Pat. No. 6,353,080, US20020122926, US20040053040, US20050175832, US20050182167, and US20050241759.

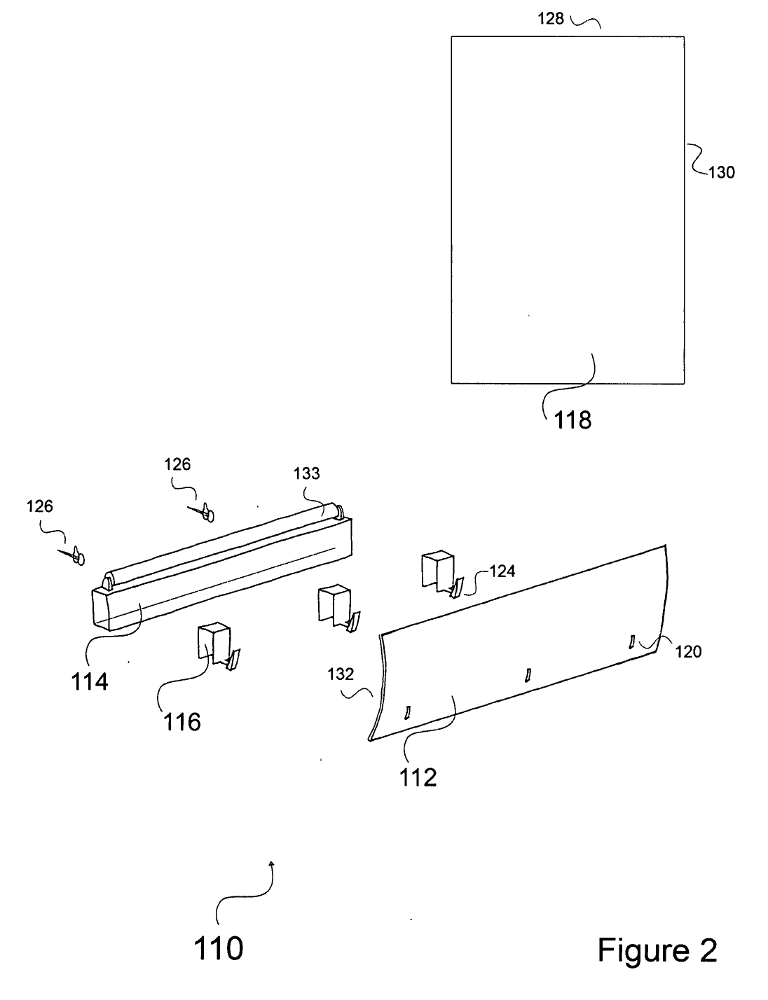

As shown in FIG. 2, in another embodiment, the lamp is in the form of a wall washer, generally referred to as 110. The wall washer 110 has a light shade 112, a receptacle 114 and mounts 116. The light shade 112 is comprised of a square sheet, which is preferably a rectangular sheet 118 of a moldable translucent laminate material, such as 3-Form™ and grommets 120 located proximate to at least two corners 122 and additionally along the length 130 of the sheet 118. Toggles 124 are mounted on the mount 116 that can be affixed to a wall by means of screws 126. Two of the toggles 124 are mounted to the mount 116 a distance that is approximately 9/10 the width 128 of the sheet 118, and approximately 9/10 the length 130 of the sheet 118, and a third toggle 124 is mounted at distance that is approximately 9/10 the width 128 of the sheet 118 and approximately ½ the length of the sheet 130 such that the light shade 112 molds into a shape that defines a space 132 between the shade 112 and the mount 116 for housing a light source 133. The light source 133 is screwed into or otherwise attached to the receptacle 114. The light source 133 is preferably a fluorescent light. The toggles 124 permit the light shade 112 to be removed as needed, whether for cleaning or for changing the light source 133. Note that the light shade 112 can be fastened to the mount 116 by means of any releasable fastener, including grommets 120 and toggles 124.

The light shade 112 is a stackable molded form that, when fastened to the mount 116, shrouds the light source or is a stackable, flat sheet that is molded into the desired form when fastened to the mounts 116, thereby shrouding the light source.

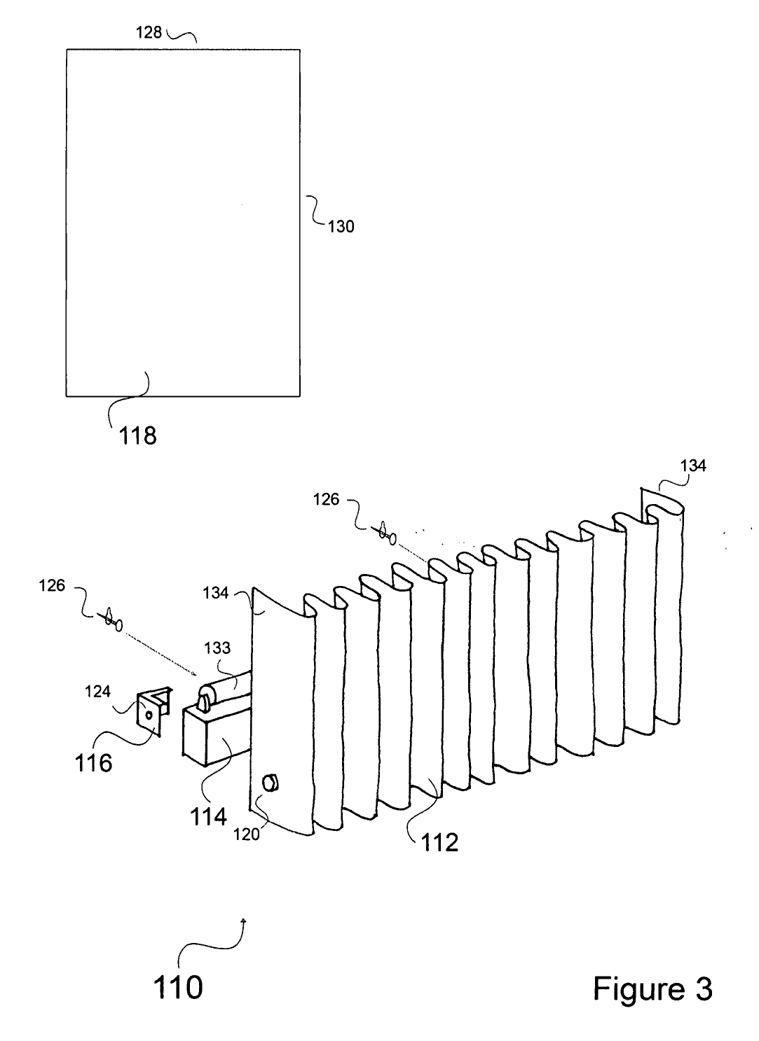

In another embodiment, the wall washer, generally referred to as 110 has a light shade 112 that is pre-formed into a stackable, nesting shape, as shown in FIG. 3, which can be mounted along a mounting side 134, as shown for a rippled form as being along the width 128 of the sheet 118. The wall washer 110 can be mounted vertically or horizontally, and if horizontally mounted can cast the light either upwards or downwards—the desired orientation will determine the mounting side. The light shade 112 can be fastened to the mount 116 by means of any releasable fastener, including grommets 120 and toggles 124.

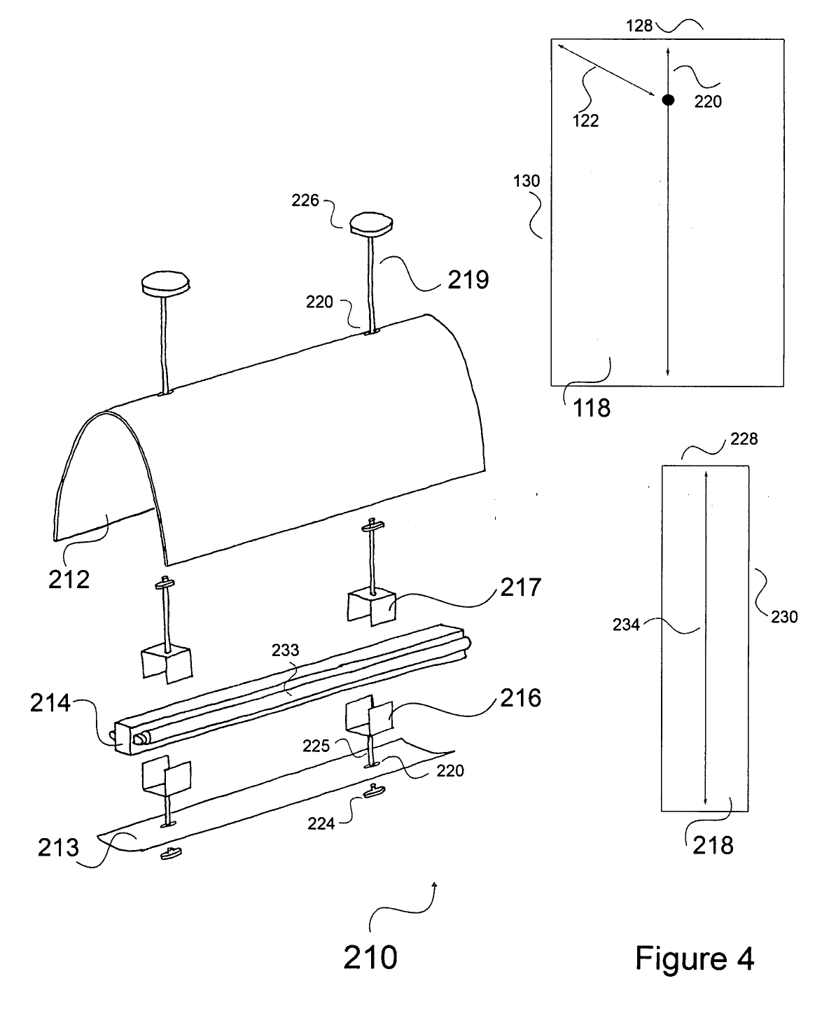

Two sheets can be used in combination to produce a ceiling light fixture, generally referred to as 210, as shown in FIG. 4. The ceiling fixture 210 has a light shade 212, a light reflector 213, a receptacle 214 and a series of mounts 216, 217, 219. The light reflector 213 is comprised of a square sheet which is preferably a rectangular sheet 218 of a moldable translucent laminate material, such as 3-Form™, that is pre-formed into a stackable, nesting shape, which can be mounted along a mounting plane 234, which can be along the length 230 or along the width 228 of the sheet 218. The light reflector 213 can be fastened to a first mount 216 by means of any releaseable fastener, including grommets 220 and toggles 224. Toggles 224 are mounted on a chain, cable or other connector 225 that extend from the first mount 216 to below the light source 233. The toggles 224 are located at distance that is approximately ½ the width 128 of the sheet 118 and approximately ⅓ the length of the sheet 130. The first mount 216 accepts the receptacle 214. The light shade 212 is comprised of a square sheet which is preferably a rectangular sheet 118 of a translucent laminate material, such as 3-Form™, and grommets 120. Toggles 224 are mounted on a chain, cable or other connector 225 that extend upward from the second mount 217. The second mount 217 accepts the receptacle 214. Again the toggles 224 are located at distance that is approximately ½ the width 128 of the sheet 118 and approximately ⅓ the length of the sheet 130. The third mount 219 can be affixed to a ceiling by means of screws 226 and retains the light shade 212. The light source 233 is preferably a fluorescent light. The toggles 224 permit the light shade 212 to be removed as needed, whether for cleaning or for changing the light source 233. Note that the light shade 212 can be fastened to the mount 216 by means of any releasable fastener, including grommets 220 and toggles 224.

The light shade 212 is a pre-formed stackable, nesting shape, preferably a trough shape and the light reflector 213 is a stackable, flat sheet.

As would be known to one skilled in the art, variations in the light assemblies and the shades that do not alter the scope of the technology are contemplated. For example, the wall sconce may preferably be a cone or cup shape, and would therefore be retained by three fasteners, that can be grommet/toggle pairs, two located generally at the top corners and a third generally centered along the bottom. Other shapes include, for example, but not limited to ellipses, two part ellipses, and various pasta shapes. The sheet may be round. The grommets and toggles can be replaced by any releasable fastener. The mount can be replaced by as many as four individual mounts. In addition to wall washers, ceiling light fixtures and sconces, floor and table lamps could be considered. The shade for the wall washer can also be used in front of any light source, including a window rather than an electric light source to diffuse the light entering through the window, thereby softening the light, inasmuch as it softens a fluorescent light source.

In the preferred embodiment the sheet is three layers thick, but it can be any number of layers. The middle layer or layers may be contain for example, but not limited to, organic materials such as handmade paper, canvas, hemp, cotton, linen, silk, other fabrics and dried plant material, metal foil, metal chips, plastic material, plastic chips and other light opaque or translucent material.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A light shade for use with a light source, said light shade comprising a sheet of a moldable, translucent laminate material and releasable fasteners, wherein said light shade is formed into a stackable shape.

2. The light shade of claim 1 wherein said light shade is further defined as a nesting shape.

3. The light shade of claim 2, wherein said laminate comprises at least three layers.

4. The light shade of claim 3 wherein at least one middle layer comprises light opaque or translucent material.

5. The light shade of claim 4 wherein said material is selected from the group consisting of organic material, metal foil, metal chips, plastic material and plastic chips.

6. The light shade of claim 5 wherein said organic material is selected from the group consisting of handmade paper, canvas, hemp, cotton, linen, silk, other fabrics and dried plant material.

7. The light shade of claim 6 wherein said fasteners are grommet and toggle pairs.

8. The light shade of claim 2 wherein said stackable, nesting shape is a sconce, a trough, a cone or a ripple.

9. A light assembly comprising a light source, a receptacle, an at least one mount and a light shade, said light shade comprising a sheet of a moldable, translucent laminate material comprising at least three layers, wherein at least one middle layer comprises light opaque or translucent material, wherein said light shade is releasably affixed to the at least one mount with at least two fasteners, to define a space, wherein said sheet has an area larger than an area defined by said at least one mount and said light source is located within said space.

10. The light assembly of claim 9, wherein said shade is formed into a stackable, nesting shape.

11. The light assembly of claim 10 wherein said stackable, nesting shape is a sconce, a trough, a ripple, or a cone.

12. A method of manufacturing a light assembly comprising a stackable, nesting light shade, said method comprising:
(i) molding a sheet of moldable, translucent laminate material to produce a pre-formed nestable shape; and
(ii) releasably attaching said pre-formed nestable shape to an at least one mount with at least two fasteners, to define a space, wherein a light source is located within said space, thereby manufacturing a light assembly.

13. The method of claim 12 further comprising selecting a square sheet and molding it into a sconce, a trough or a ripple shape.

14. The method of claim 12 further comprising selecting a triangular sheet and molding it into a cone shape.

15. The method of claim 12 wherein said laminate material comprises at least three layers.

16. A light shade for shrouding a light source, said light shade made by releasably attaching a sheet of a moldable, translucent laminate material to an at least one mount with at least two fasteners, to define a space, wherein said sheet has an area larger than an area defined by said at least one mount and said light source is located within said space, thereby shrouding the light source with the light shade.

17. The light shade of claim 16, wherein said laminate comprises at least three layers.

18. The light shade of claim 17 wherein at least one middle layer comprises light opaque or translucent material.

19. The light shade of claim 18 wherein said material is selected from the group consisting of organic material, metal foil, metal chips, plastic material and plastic chips.

20. The light shade of claim 19 wherein said organic material is selected from the group consisting of handmade paper, canvas, hemp, cotton, linen, silk, other fabrics and dried plant material.

21. The light shade of claim 17 comprising a square sheet and four fasteners.

22. The light shade of claim 21 wherein said fasteners are grommet and toggle pairs.

23. The light shade of claim 17 comprising a triangular sheet and three fasteners.

24. The light shade of claim 23 wherein said fasteners are grommet and toggle pairs.
